(19) United States
(12) Patent Application Publication
(10) Pub. No.: US 2013/0188217 A1
(43) Pub. Date: Jul. 25, 2013

(54) SYSTEM AND METHOD FOR ONLINE COUPON PRINTING

(71) Applicant: COUPONCABIN LLC, Whiting, IN (US)

(72) Inventor: Scott E. Kluth, Chicago, IL (US)

(73) Assignee: COUPONCABIN LLC, Whiting, IN (US)

(21) Appl. No.: 13/745,595

(22) Filed: Jan. 18, 2013

Related U.S. Application Data
(60) Provisional application No. 61/588,921, filed on Jan. 20, 2012.

(51) Int. Cl. G06F 9/445; G06F 3/12

(52) U.S. Cl. CPC G06F 8/61; G06F 3/12
USPC 358/1.14; 717/177; 358/1.15

(57) ABSTRACT

A method and system that facilitates a coupon aggregator website that receives coupon objects corresponding to one of a plurality of distinct plug-ins stored on a plurality of remote servers. Each distinct plug-in is used in printing the coupon object corresponding to the plug-in. The method and system also facilitate hosting a batch installer. The batch installer corresponds to the distinct plug-ins stored on the remote servers. The method and system send the batch installer to the client computing device in response to a request from the client computing device. The batch installer causes one or more remote servers to send its plug-in to the client computing device, causes the installation of each sent plug-in on the remote computing device; and sends a coupon object to the client computing device in which the sent coupon object corresponds to one of the plug-ins installed on the client computing device.

### TECHNICAL FIELD

The present disclosure generally relates to a system and method for electronically distributing and printing a coupon for shoppers obtained from a coupon aggregator's website, and, more particularly, for electronically distributing and printing coupons for coupon seekers to use in a brick and mortar store.

### BACKGROUND

Manufacturers and retailers have been employing coupons to entice customers to try new or existing products since the late 19^{th} Century. Historically, these coupons were pieces of paper distributed by company representatives, publications, direct mail, etc. However, the rise of the personal computer and the Internet has revolutionized shopping. Many transactions that twenty years ago would have occurred in a brick and mortar store are now taking place electronically. To entice these Internet shoppers, sellers of goods and services distribute online coupons through various avenues. A typical example of an online coupon is not a piece of paper as in the past, but a special hyperlink or character string that will trigger the computers and servers operating the electronic retailer to apply a discount or other incentive to the electronic shopper sometime before payment is made.

As prevalent as Internet shopping has become, there are many consumers who prefer to personally inspect the item they are contemplating purchasing. This is especially true for grocery stores. Consumers may wish to see if a piece of produce is ripe or to see if a can of soup is dented before purchasing it. However, as the Internet was revolutionizing the retail industry, it was likewise causing changes in other industries relating to the traditional distribution of coupons, most notably printing and publishing. Whereas twenty years ago newspapers and magazines were important channels for advertising and distributing coupons, many people now eschew traditional media preferring to get the same content online. Additionally, more electronic mail is sent each year than print mail. But, the model of electronic distribution of coupons to be used in brick and mortar stores has a hurdle that online coupons used in online stores do not: the need to print a physical copy of the coupon to take to the store.

This need to make a physical copy is problematic in an online context. Traditional coupons are printed by the company offering the discount or by a third-party printer with whom that company has a relationship. The company can set a numerical limit on the number of coupons printed and can set a geographical limit on their distribution. In Internet shopping, online coupons are presented electronically to the sophisticated computer system operating the website. It is well within the capabilities of such computer systems to limit how many times or from where a discount is redeemed. Such a computer system could put other more sophisticated limitations on an electronic coupon. However, brick and mortar stores generally do not have the capability to place limitations on coupons in the same manner as Internet stores. If a consumer is allowed to print as many copies of a coupon as he or she desires and is able to redeem them, a deal offered by a brick and mortar retailer could backfire. Too many copies of electronic coupons could eliminate the possibility of profit on the particular deal. Thus, it has become imperative for companies that distribute electronic coupons to be used at brick and mortar stores to limit the number of times a particular coupon can be printed.

Distributors of electronic coupons have developed ways to limit the number of times a particular coupon can be printed. A common method is by way of a browser plug-in. Consumers access websites using programs called browsers that interpret the binary streams of data by which the code of a website is transmitted. These browsers decode the data stream and display the resulting website on the consumer's screen. Browser plug-ins are comparatively smaller sets of program instructions that modify how the browser operates. In the case of coupons, a plug-in limits the number of times a coupon can be printed. However, each electronic coupon distributor uses a proprietary browser plug-in. Many consumers prefer to look for online coupons through aggregator websites that have the ability to post coupons from various providers. However, because each provider requires users to print via their respective printer plug-ins, coupon aggregators are forced to organize their sites by providers to ensure that the appropriate commands to install and use the printer plug-in are issued and executed. There are three problems with this current scheme. First, coupon aggregators must organize their websites by providers rather than a more consumer useful scheme (e.g., grouping coupons for canned soup on one page). Second, since coupons from different providers cannot be displayed on the same page, competition is reduced between different providers. Third, a new customer who wants to print coupons from two or more different providers must endure repetitive installation procedures as each provider plug-in is installed separately. Repetitive installations of printer plug-ins for each coupon vendor may be costly and time consuming and may undermine the viability of the electronic coupon distribution model.

### SUMMARY

Features and advantages described in this summary and the following detailed description are not all-inclusive. Additional features and advantages may be apparent to one of ordinary skill in the art in view of the drawings, specification, and claims hereof. Additionally, other embodiments may omit one or more (or all) of the features and advantages described in this summary.

In accordance with this disclosure, a method may receive, at a coupon aggregator system, printable coupon objects corresponding to one of a plurality of distinct plug-ins stored on a plurality of remote servers, each distinct plug-in including instructions that, upon execution, format the printable coupon object corresponding to the distinct plug-in for printing at a client computing device; electronically host, at the coupon aggregator system, a coupon aggregator website and a batch installer, the batch installer corresponding to the distinct plug-ins stored on the remote servers; send the batch installer from the coupon aggregator website to the client computing device in response to a request from the client computing device, the batch installer including instructions that, upon execution: cause one or more remote servers having a distinct plug-in corresponding to the batch installer to send its distinct plug-in to the client computing device, cause the installation of each sent distinct plug-in on the remote computing device; and send a printable coupon object to the client computing device from the coupon aggregator system, the sent printable coupon object corresponding to one of the distinct plug-ins installed on the client computing device.

In further embodiments, a system may comprise a backend server including a first processor and a first program memory storing instructions for execution by the first processor to: receive printable coupon objects corresponding to one of a plurality of distinct plug-ins stored on a plurality of provider servers each distinct plug-in including instructions that, upon execution, format the printable coupon object corresponding to the distinct plug-in for printing at a client computing device, and host a coupon aggregator website and a batch installer; a plurality of provider servers communicatively coupled to the backend server, each server including a second processor and a second program memory storing a distinct provider plug-in, and instructions for execution by each second processor to send the distinct provider plug-in to the client computing device; and a client computing device communicatively coupled to the backend server including a third processor and a third program memory storing instructions for execution by the third processor to receive the batch installer; wherein the batch installer includes instructions for execution by the third processor to: cause the plurality of provider servers to having a distinct plug-in corresponding to the batch installer to send its distinct plug-in to the client computing device, and cause the installation of each sent distinct plug-in on the remote computing device.

In still further embodiments, a tangible computer readable medium storing instructions adapted for execution by a processor, the instructions, when executed, cause the processor to receive, at a coupon aggregator system, printable coupon objects corresponding to one of a plurality of distinct plug-ins stored on a plurality of remote servers, each distinct plug-in including instructions that, upon execution, format the printable coupon object corresponding to the distinct plug-in for printing at a client computing device; electronically host, at the coupon aggregator system, a coupon aggregator website and a batch installer, the batch installer corresponding to the distinct plug-ins stored on the remote servers; send the batch installer from the coupon aggregator website to the client computing device in response to a request from the client computing device, the batch installer including instructions that, upon execution: cause one or more remote servers having a distinct plug-in corresponding to the batch installer to send its distinct plug-in to the client computing device, cause the installation of each sent distinct plug-in on the remote computing device; and send a printable coupon object to the client computing device from the coupon aggregator system, the sent printable coupon object corresponding to one of the distinct plug-ins installed on the client computing device.

### BRIEF DESCRIPTION OF THE DRAWINGS

FIG. 1 illustrates one exemplary block diagram of one embodiment for a computer network and system on which a coupon distribution and printing system may operate in accordance with the described embodiments;

FIG. 1A illustrates another exemplary block diagram of another embodiment for a computer network and system on which a coupon distribution and printing system may operate in accordance with the described embodiments;

FIG. 1B illustrates an exemplary block diagram of one embodiment for a coupon object in a computer network and system on which a coupon distribution and printing system may operate in accordance with the described embodiments;

FIG. 2A illustrates an exemplary block diagram of a flow chart for one embodiment of a batch installation procedure for coupon provider plug-ins;

FIG. 2B illustrates an exemplary block diagram of a flow chart for one embodiment of a method for limiting the number of times a coupon appearing on an aggregator site can be printed;

FIG. 3A illustrates an exemplary block diagram of a flow chart for another embodiment of an integrated installation procedure for a coupon aggregator multi-plug-in;

FIG. 3B illustrates an exemplary block diagram of a flow chart for another embodiment of a method for limiting the number of times a coupon appearing on an aggregator site can be printed;

FIG. 4 illustrates an exemplary screenshot of one embodiment for a coupon aggregator website displaying a plurality of coupon objects; and

FIG. 5 illustrates an exemplary method for using the system for distribution and printing of online coupons.

### DETAILED DESCRIPTION

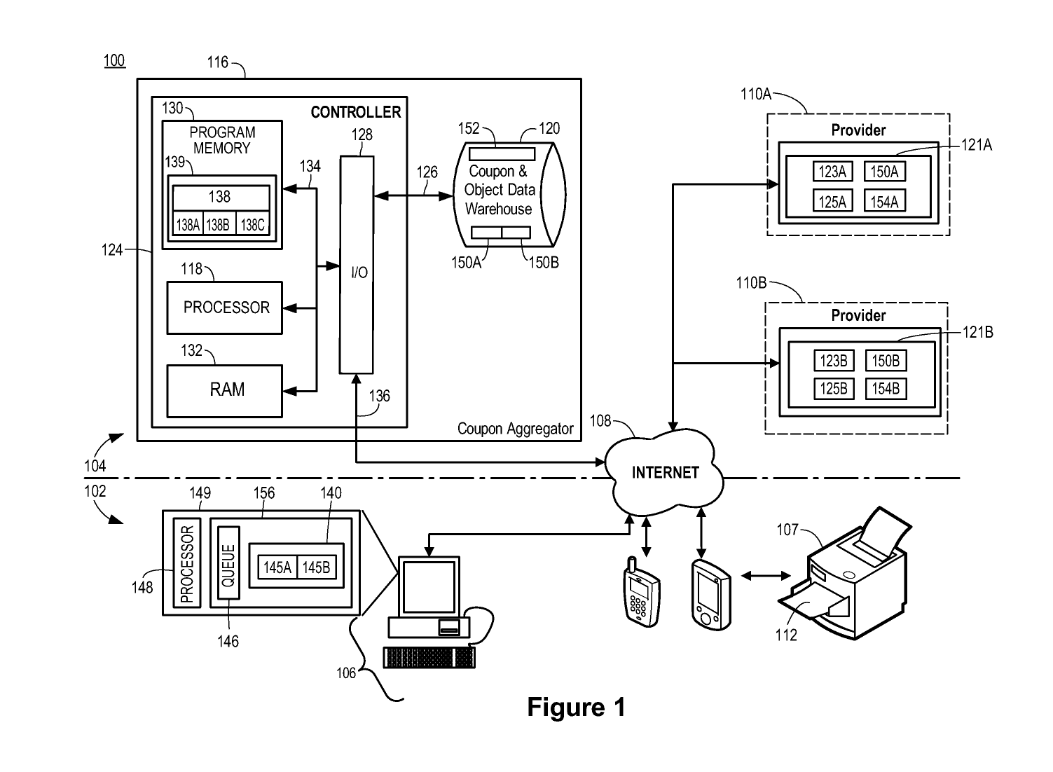

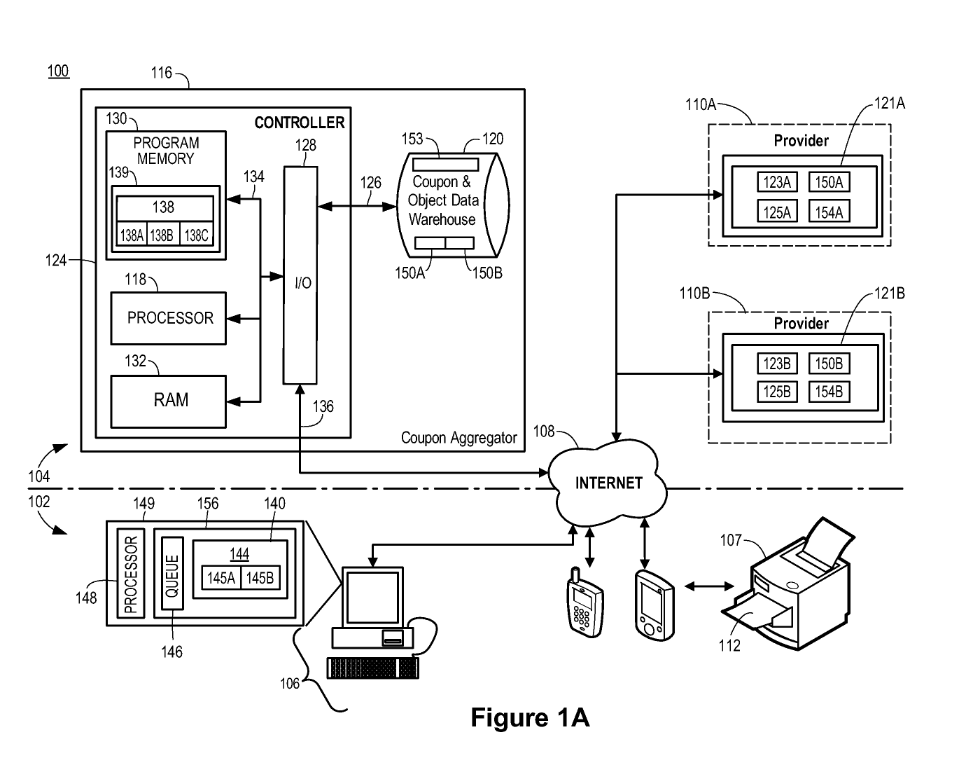

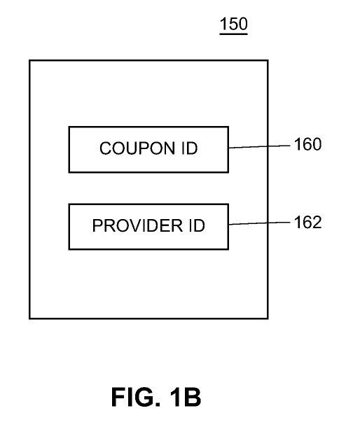

FIG. 1 illustrates various aspects of an exemplary architecture implementing an online system and method for electronically distributing coupons and controlling the number of times a coupon can be printed 100. In particular, FIG. 1 illustrates a block diagram of the exemplary online coupon distribution and printing system 100. The high-level architecture includes both hardware and software applications, as well as various data communications channels for communicating data between the various hardware and software components. The online coupon distribution and printing system 100 may be roughly divided into front-end components 102 and back-end components 104. The front-end components 102 are primarily web-enabled devices 106 (personal computers, smart phones, PDAs, televisions, etc.) connected to the Internet 108 by one or more customers and printers 107 that are interfaced with the web-enabled devices 106.

The front-end components 102 communicate with the back-end components 104 via the Internet or other digital network 108. In some embodiments, the web-enabled devices 106 may communicate with the back-end components via the Internet 108. The digital network 108 may be a proprietary network, a secure public Internet, a LAN, a virtual private network or some other type of network, such as dedicated access lines, plain ordinary telephone lines, satellite links, combinations of these, etc. Where the digital network 108 comprises the Internet, data communication may take place over the digital network 108 via an Internet communication protocol. The back-end components 104 include a coupon aggregator system 116 or “aggregator” such as CouponCabin.com® or other internet-based, publicly-accessible system and at least one provider 110. Additionally or alternatively, the coupon aggregator system 116 may be a web server in communication with a private or secure LAN. The coupon aggregator system 116 includes a controller 124 with hardware and software configured to operate the coupon aggregator system 116 and host the coupon aggregator website 139. The coupon aggregator system 116 may include one or more computer processors 118 adapted and configured to execute various software applications, modules, functions, routines, and components of the online coupon distribution and printing system 100. These various applications, etc., may, in addition to other software applications, allow an aggregator to host a coupon aggregator website 139 and batch plug-in installer 152, as further described below. The coupon aggregator system or web server 116 further includes a data warehouse or database 120. The data warehouse 120 is adapted to receive and store coupon objects 150 and the plug-in batch installer 152, but it should also be understood that the coupon objects 150 and plug-in batch installer 152 could be stored elsewhere such as in the program memory 130. As shown in FIG. 1B, each coupon object may include a unique coupon identification code 160 and a provider code 162 associated with the provider of the coupon. The coupon objects 150 may further contain graphics or videos of the product or service, textual information regarding the name of the brand or maker of the product or service, a description of the discount offer and its terms, information regarding the source of the coupon (i.e., an provider system or retailer), a hyperlink or script that points to the corresponding coupon object 150 at the provider 110, the software version of the plug-in 145 required to print the coupon, an identifier (e.g., a number, code, tag, etc.) which corresponds to the aggregator site 139, as well as other elements. Coupon objects 150 may be assembled, stored in the data warehouse 120 or program memory 130, and posted to the website as new coupons become available and removed or flagged as “expired” when the coupon offers have ended. The coupon aggregator system 116 may access data stored in the data warehouse 120 when executing various functions and tasks associated with the operation of the online coupon distribution and printing system 100, as described herein.

Although the online coupon distribution and printing system 100 is shown to include a coupon aggregator system 116 in communication with one web enabled device 106, a printer 107, and two providers 110A and 110B, it should be understood that different numbers of processing systems, computers, customers, provider systems, and printers may be utilized. For example, the Internet 108 may interconnect the system 100 to a plurality of coupon aggregator systems, other provider systems 110A, 110B, a vast number of web-enabled devices 106, and several printers 107. According to the disclosed example, this configuration may provide several advantages, such as, for example, enabling near real-time updates of coupons from the system 100 via the providers 110A and 110B, changes to the discount links or coupons from the providers 110A and 110B, as well as periodic uploads and downloads of information.

The system 100 may also include one or more web servers 121A and 121B. These servers 121A, 121B may each include a controller similar to the controller 124 described above with similar functionality and including data and objects to host a website. All servers may further include a display and a keyboard as well as a variety of other input/output devices (not shown) such as a scanner, printer, mouse, touch screen, track pad, track ball, isopoint, voice recognition system, digital camera, etc.

The provider system 110 web server 121 may include information, applications, modules, routines, instructions, etc., to host a provider plug-in installation program 154, interface with a client device 106 that has the plug-in 145 installed, and identify the coupon aggregator system 116. The provider system 110 may also include a web server 121 including information, applications, modules, routines, instructions, graphics, objects, etc., to facilitate the electronic distribution of a coupon to a web-enabled device 106 and the printing of the coupon on a printer 107, as further explained herein. Each web server 121 may be a computing apparatus that includes a memory 123 to store the information, applications, etc., and a processor or controller 125 to execute the various applications, routines, modules, instructions, etc., as also described herein. The affiliate web server 121 may also be configured to store a provider plug-in installation program 154 which facilities the printing of electronically distributed coupons and a coupon object 150 which may act as a counterpart to the aggregator coupon object 150 discussed herein.

The coupon aggregator system 116 depicted in FIG. 1 may include a controller 124 operatively connected to the data warehouse 120 via a link 126 connected to an input/output (I/O) circuit 128. It should be noted that, while not shown, additional databases or data warehouses may be linked to the controller 124 in a known manner. The controller 124 includes a program memory 130, the processor 118 (may be called a microcontroller or a microprocessor), a random-access memory (RAM) 132, and the input/output (I/O) circuit 128, all of which are interconnected via an address/data bus 134. It should be appreciated that although only one microprocessor 118 is shown, the controller 124 may include multiple microprocessors 118. Similarly, the memory of the controller 130 may include multiple RAMs 132 and multiple program memories 130. Although the I/O circuit 128 is shown as a single block, it should be appreciated that the I/O circuit 128 may include a number of different types of I/O circuits. The RAM(s) 132 and the program memories 130 may be implemented as a computer-readable storage memory such as one or more semiconductor memories, magnetically readable memories, and/or optically readable memories, for example. A link 136 may operatively connect the controller 124 to the Internet 108 through the I/O circuit 128.

Each personal network-enabled device 106 may include a controller 149 similar to the controller 124 in the aggregator system 116. Such a controller 149 may include a processor 148 and/or a program memory 156. Additionally, each personal network-enabled device 106 may also include or be operatively connected to a removable, non-volatile memory device to access computer-readable storage memories. The non-volatile memory device may include an optical or magnetic disc reader, USB or other serial device ports, and other access to computer-readable storage memories. In some embodiments, methods, modules, instructions, etc., described herein may be stored on a computer-readable memory that is accessible by or a component of the coupon aggregator system 116 and the personal devices 106 so that the methods, modules, instructions, etc., may be temporarily transferred to the program memory 130, 156 and controllers 124, 149 for execution, as described herein.

A printer 107 may be connected to at least one of the personal network-enabled devices 106. The printer 107 could be connected to the personal network-enabled devices 106 by a direct cable (e.g., USB, parallel, serial, or other types of cable) or through a switch, hub, router etc., or wirelessly using a wireless network protocol (e.g., IEEE standards 802/11a, b, g, n or standards to be developed). It may be advantageous for the printer 107 to have drivers or other kinds of software (e.g., a printer queue 146) installed on the personal network-enabled device 106 to facilitate printing.

The coupon distribution and printing system 100 may have various different structures and methods of operation. It should also be understood that while the embodiment shown in FIG. 1 illustrates some of the components and data connections that may be present in a coupon distribution and printing system 100, it does not illustrate all of the data connections that may be present. For exemplary purposes, one design of a coupon distribution and printing system 100 is described herein, but it should be understood that numerous other designs may be utilized. By way of illustration, FIG. 1A shows a second embodiment of a distribution and printing system 100 similar to the embodiment described in FIG. 1. However, FIG. 1A differs from FIG. 1 in that instead of a batch installer 152 the coupon aggregator 116 may be configured to host a multi-plug-in installation program 153 which may install a multi-plug-in framework 144 in addition to facilitating the installation of the provider plug-ins 145 described herein.

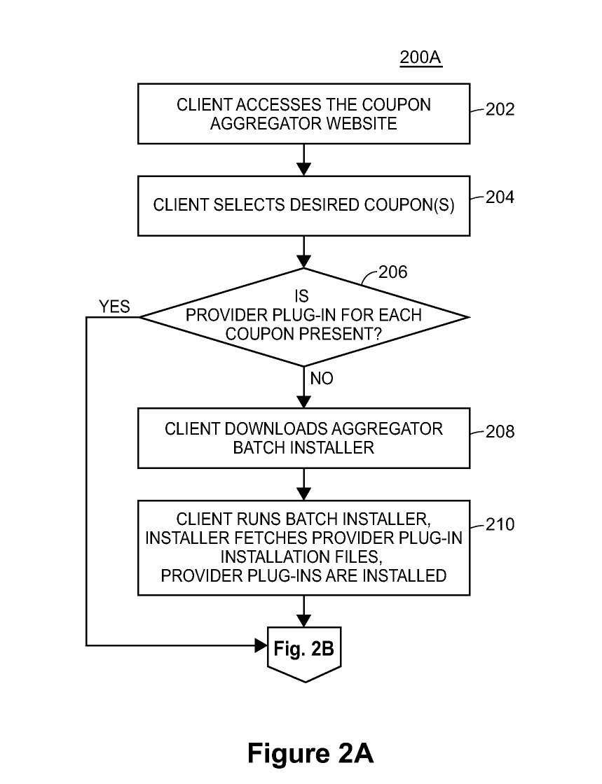

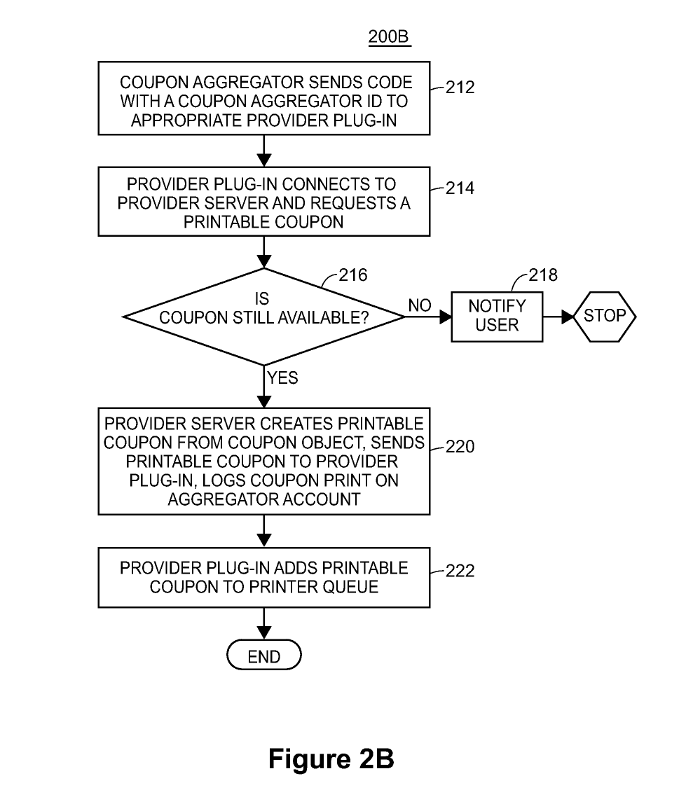

FIG. 2A illustrates another embodiment of a plug-in installation procedure 200A to allow electronic distribution and printing of coupons. The embodiment described in FIG. 2A includes the use of a batch installer file that runs on a client computer to fetch and install the provider plug-ins for each coupon provider. At block 202, the client may access the coupon aggregator website and search or browse for coupons in the manner discussed herein. At block 204, the client may select one or more coupons to print. At decision point 206, the website 139 may query the client's browser to check for the presence of the appropriate provider plug-ins 145 that correspond to the coupons the client selected. For example, decision point 206 may include instruction that, when executed on a processor, check the memory of the web-enabled device 106 for the provider plug-ins 145. In some embodiments, the instructions may cause a processor to look for the installation of a specific shared library file (e.g., a DLL file etc.) that comprises the appropriate provider plug-in 145. In other embodiments, the provider plug-ins may comprise programs that are stand-alone executable from the browser program (e.g., an .EXE program, etc.). In such an embodiment, the batch installer may search the program memory 156 or other kind of memory of the web-enabled device 106 for the provider plug-in executable program at decision point 206. If the client's device 106 does not have the appropriate provider plug-in 145 installed for one or more of the selected coupons, the system 100 may execute instructions to cause a batch installer file 152 to be downloaded to memory 156. For example, backend system or the client's web-enabled device 106 may execute instructions to download the batch installer file 152 to memory 156 through the Internet 108 at block 208. In some embodiments, the batch installer 152 is an independently executable file that runs on the web-enabled device 106. In other embodiments the batch installer 152 is a script that is run or interpreted by the browser 140 on the web-enabled device 106. In still other embodiments, the batch installer 152 may have a plurality of components where at least one component operates as an independently executable file and at least one other component operates as a script that is run by the browser 140. In still other embodiments discussed herein, the batch installer file 152 is an installation program that installs an affiliate multi-plug-in framework 144 in addition to facilitating the installation of the provider plug-ins 145.

At block 210, the batch installer 152 may cause instructions be executed to fetch the installation files 154 from each provider. Each provider makes coupons available to be posted to the website 139. The batch installer 152 may be an executable file that accesses URLs corresponding to the locations of the individual provider plug-in installation files 154. The installer 152 may cause instructions to be executed by the client device 106 to download the provider plug-in installation files 154 to memory 156 one at a time, simultaneously, or in groups. In other embodiments, the provider server 110 may push the provider plug-in installation files 154 to memory 156 one at a time, simultaneously, or in groups. The batch installer 152 may wait until each plug-in installation file 154 is completely downloaded before beginning installation, or the batch installer 152 may handle the installation of each provider plug-in individually (e.g., downloading and installing the plug-in 145 from a first provider then downloading and installing the plug-in 145 from a second provider etc.). The batch installer file 152 may continue to execute while the file 152 causes instructions to be executed to walk the user through the installation procedures 154 for each provider plug-in 145. The plug-in installation programs 154 may also include additional downloads, may add one or more files to the client device's 106 memory 156 (e.g., adding a plug-in shared library file), and may change files stored in memory 156 (e.g., changing the configuration of the browser 140 to accommodate the new plug-in). In some embodiments, the provider plug-ins 145 may be installed serially while in others, the provider plug-ins 145 may be installed in one or more groups. In some embodiments, the batch installer may execute the provider plug-in installation programs 154 in a modified way. Such modifications may include adding aggregator identifier information to the installation, adding header and/or footer information to the plug-in code, and altering hyperlinks in the plug-in. Once the last provider plug-in has been installed, the batch installation file 152 terminates.

With reference to FIG. 2B, after the user has logged on to the aggregator website, selected one or more coupons to print, and installed the provider plug-ins (see FIG. 2A), the coupon aggregator website 139 may send the coupon object 150 or one or more codes associated with the coupon object 150 to the provider plug-in 145 installed on the client device 106 at block 212. Alternatively, the aggregator system 116 may send the coupon object 150 or one or more codes associated with the coupon object 150 to the provider server 121. If the user selected more than one coupon to print, the aggregator may group the coupon objects 150 or one or more codes associated with the coupon objects 150 individually or in batches grouped by provider or coupon type. In some embodiments, the aggregator system 116 may send a batch and wait for the completion of the coupon printing process described herein before sending a batch of coupons from a different provider for printing.

As shown in FIG. 1B, each coupon object 150 may include a unique coupon identifier 160 and a provider identifier 162. The unique coupon identifier 160 may be used by the aggregator system 116, the provider server 121, and/or the provider plug-in 145 to differentiate a coupon object 150 from other coupon objects 150. The provider identifier 162 allows the aggregator system 116 and/or the provider plug-ins 145 to know which provider server 121 from which to request a printable coupon. Additionally, the coupon object 150 may include an affiliate identifier (not shown) that corresponds to the coupon aggregator website 139. This affiliate identifier may allow the provider system to credit the coupon aggregator system 116 for a successful coupon printing to keep track of the number of times any particular coupon is printed. Alternatively, in embodiments discussed herein where the aggregator system 116 sends the coupon object 150 or one or more codes associated with the coupon object 150 to the provider server 121, the aggregator system 116 may increment a counter to track the number of times the coupon has been printed.

At block 214, each provider plug-in 145 on the client device 106 may be sent the print code associated with the selected coupon objects 150. Each plug-in 145 may also communicate with its associated provider 110. After completing a log in process, the provider plug-in 145 may execute instructions to request that the provider 110 prepare and send a printable version of the coupon object 150. At decision point 216, the provider system may execute instructions to check if the coupon represented by the coupon object 150 is still available (i.e., has not exceeded its maximum number of prints, has not expired or been removed, etc.). If the coupon is no longer available, the provider system 110 may send a command to the provider plug-in 145 to notify the user with a message at block 218. The message could include a pop-up window with an interactive control or some other notification using graphics and/or text and may inform the user of the discontinuation or expiration of the coupon, may further inform the user of other coupons that may be of interest to the user, etc.

If the coupon is still available, the provider server may execute instructions to prepare a printable version of the coupon object 150 at block 220. Such preparations may include creating a unique barcode (e.g., a one dimensional linear barcode or a two dimensional barcode) or other scannable coupon identifier and/or formatting the printable coupon in such a way as to make photocopying impracticable. Such formatting might include the use of small text or fine details on a picture or diagram that may prevent photocopying by being too fine to be scanned and duplicated effectively by photocopiers and scanners. In some embodiments, the provider server 121A, 121B may add a provider company trademark or other source designation such as a logo to the printable coupon. Further steps in preparing a printable version of the coupon object 150 may include combining the scannable identifier with the formatting into a high quality image file (e.g., a TIF file, a PNG file, a GIF file, a JPG file, etc.), a PDF file, or another type of printable coupon file. This printable coupon file may be sent through the Internet 108 to the provider plug-in 145 on the client device 106. Alternatively, the printable coupon file may be sent through the Internet 108 to the aggregator system 116 which then may sent the printable coupon file to the client device 106. Once the file has been received by the provider plug-in 145 or at an earlier time during the preparation of the printable coupon, the provider system may make a log indicating that a print request was received and may include the affiliate identifier that corresponds to the aggregator website 139. The log might be used to apply a credit to the aggregator website's 139 account with the provider 110. The credit may be used to calculate a payment made by the provider 110 to the aggregator 116 for the referral. Once the provider plug-in 145 has received the printable coupon file, the provider plug-in may send the file to the printer 107. The provider plug-in 145 may provide the user with a choice as to which printer 107 to use or the provider plug-in 145 may require the user to print to the default printer 107. The provider plug-in 145 may facilitate printing by adding the printable coupon file to the printer queue 146 on the client device 106 at block 222. If the user is printing more than one printable coupon file, the printable coupon files may be added to the printer queue as a single print job with multiple coupons, as separate print jobs for each coupon, or as provider-specific print jobs wherein all the printable coupons from the same provider are grouped together. The printer may then print the coupon to create a physical coupon 112 that can be used at a brick and mortar store.

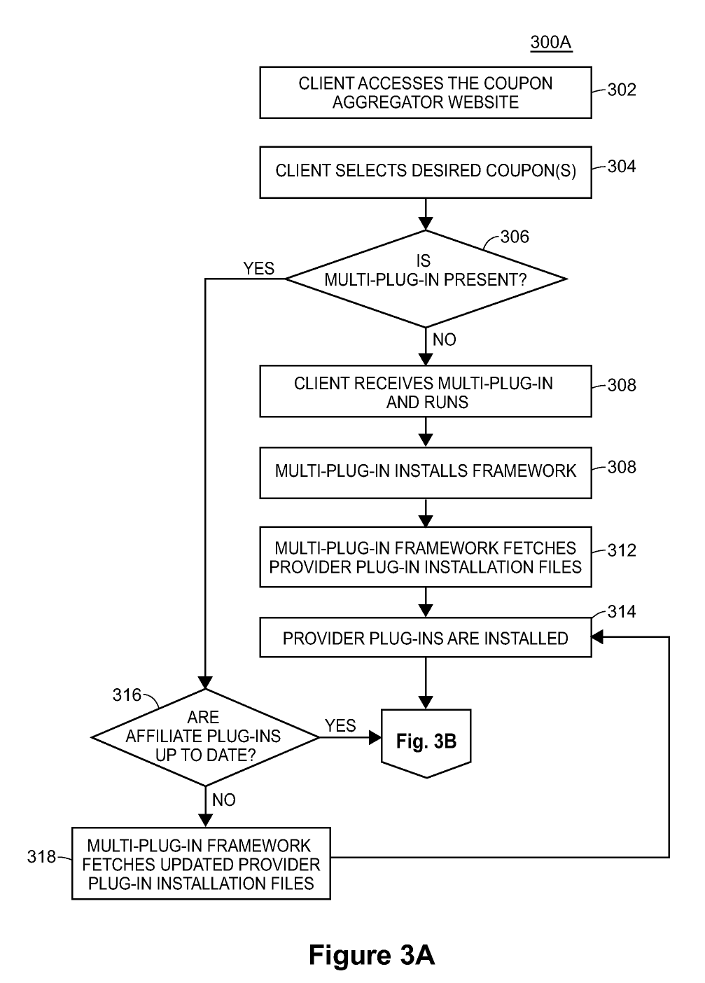

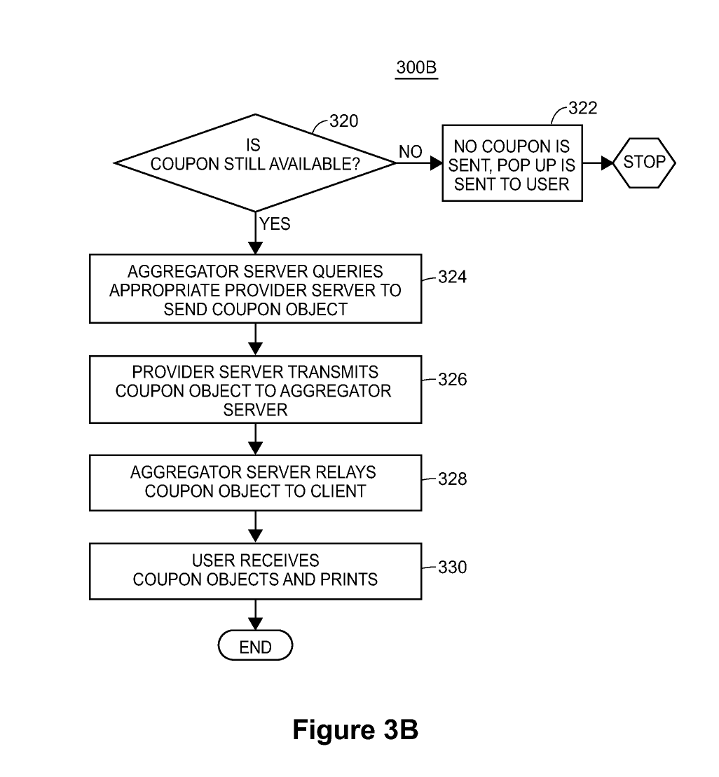

FIG. 3A illustrates another embodiment of a plug-in installation procedure 300A to allow electronic distribution and printing of coupons using a multi-plug-in framework 144. Generally, the multi-plug-in framework 144 may include a browser plug-in or other type of application that is installed on the client device 106 and that facilitates the installation and management of the various provider plug-in applications, as herein described. The multi plug-in framework 144 may comprise a set of instructions that alters the execution of a browser program 140 such as one or more shared library files. Additionally or alternatively, the multi-plug-in framework 144 may comprise programs, applications, apps, or applets that are executed independently of the browser 140. At block 302, the user may initiate instructions stored in a memory and executed on a processor to launch the browser 140 which may access the Internet 108 to visit the coupon aggregator website 139 hosted by aggregator server 116. The aggregator website 139 may include a plurality of web pages each made up of objects formatted using a hypertext language such as HTML, XHTML, etc., and may provide navigation to other web pages via hypertext links.

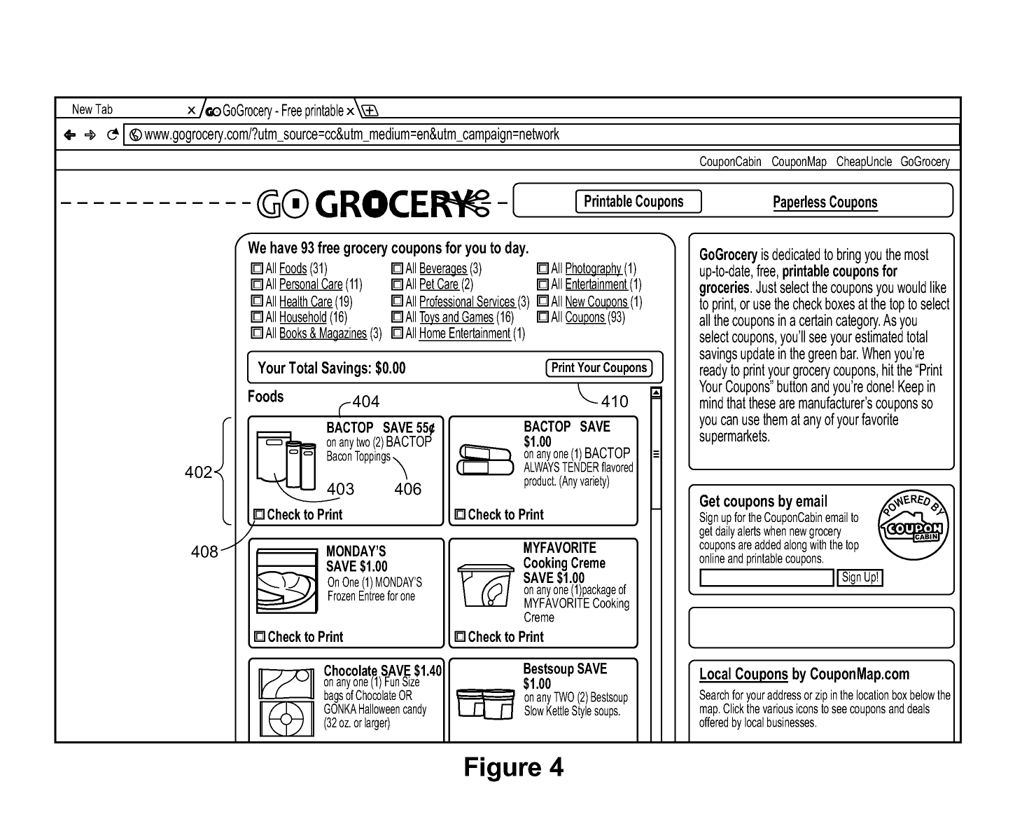

After searching for coupons and/or browsing for coupons, the user may select a coupon he or she would like to print at block 304. Selection of a coupon image 402 (see FIG. 4) may cause instructions to be executed by a processor to query the web-enabled device 106 at block 306 to determine if the device is capable of printing the coupon associated with the coupon image 402. In some embodiments, block 306 causes a function to be executed on a processor to discover if a printing application such as the multi-plug-in framework 144 or the provider plug-ins 145 is installed on the network-enabled device 106. Such a function may include checking the memory of the web-enabled device 106 for the multi-plug-in framework 144, plug-ins, 145, etc., by looking for the installation of a specific shared library file (e.g., such as a DLL file) that comprises the multi-plug-in framework 144 and/or the provider plug-in 145. If the multi-plug-in framework 144 is not installed on the browser 140, the coupon aggregator website 139 hosted by the aggregator server 116 may execute instructions to prompt the user to run the multi-plug-in installation program 153 at block 308 and install the multi-plug-in framework 144. Once installation has begun, the multi-plug-in installation program 153 may install the multi-plug-in framework 144 at block 310.

In general, the multi-plug-in framework 144 includes instructions that describe an interface between the browser 140 and the provider plug-ins 145. Such an interface may include instructions for sending and receiving electronic information to and from both the browser and the provider plug-ins where the multi-plug-in framework 144 acts as an intermediary. The multi-plug-in framework 144 may further include the ability to translate the data type, format, or other characteristics of the electronic information that the multi-plug-in framework 144 passes between the browser 140 and provider plug-ins 145. The electronic information that the multi-plug-in framework 144 passes between the browser 140 and provider plug-ins 145 may be XML, JSON, or another format. The installed multi-plug-in framework 144 may include a shared library file installed in memory on the web-enabled device 106. Such a multi-plug-in framework 144 shared library file may be loaded at runtime by the browser 140 and may include instructions to communicate with and modify the functions of the browser application 140 using an Application Programming Interface (API). The browser 140 may be configured by the user to disable or uninstall the multi-plug-in framework 144 at the user's request.

Once the multi-plug-in framework 144 plug-in has been installed, the multi-plug-in framework 144 may fetch the provider plug-in installation programs 154 from a local or remote host to install the provider plug-ins 145 at block 312. In some embodiments, there may be a plurality of provider plug-in installation programs 154A-B that may be hosted on corresponding provider system servers 121A-B. At block 314, provider plug-ins 145 may be installed per installation files 154 determined by the host servers 121, or by other procedures. The provider plug-ins may comprise files that alter the execution of a browser program 140 such as shared library files or the provider plug-ins may comprise programs, applications, apps, or applets that are executed independently of the browser 140. In some embodiments, the plug-ins 145 may be installed into the memory of the web-enabled device 106 in one or more groups or one at a time. However, the multi-plug-in framework 144 may also execute the provider plug-in installation files 154 in a modified way to allow for incorporation into the multi-plug-in framework 144. For example, the installation files 154 may be modified to incorporate the instructions contained in the shared library files comprising the provider plug-ins 145 into a single multi-plug-in shared library file such that the user may not be aware of the presence of the provider plug-ins 145 but rather may only have visibility of a single multi-plug-in framework 144. In other embodiments, provider plug-in installation files 154 may be executed in a modified batch such that the user does not have to click through the installation prompts for each individual provider plug-in 145. In still further embodiments, the multi-plug-in may more fully incorporate the coupon printing functions described herein. In such an embodiment, the multi-plug-in installation file 153 might install a multi-plug-in framework 144 with the program code or instructions needed to print coupons, as described by each individual provider plug-in, integrated into the multi-plug-in framework 144. In such an embodiment, the multi-plug-in framework 144 does not cause the web-enabled device 106 to access the provider servers 121 to install separate provider plug-ins as described in blocks 312 and 214. Instead, the multi-plug-in framework 144 acts in place of the provider plug-ins and performs the printing functions for all providers. Such embodiments may be advantageous to simplify the user's memory management or installation experiences.

If block 306 determines the multi-plug-in framework 144 is already installed, decision point 316 may perform another query to determine whether the appropriate provider plug-in 145 to print the coupon selected by the user at block 304 is up to date. If the appropriate provider plug-in 145 is not up to date, the multi-plug-in framework 144 may fetch the updated version of the plug-in from a local or remote host (e.g., a provider system server 121). When the plug-in 145 requires an update, the multi-plug-in framework 144 may execute instructions to install the more recent provider plug-in by downloading and installing the installation files 154 described herein, or the provider plug-in 145 may execute a function to call the provider system server 121 and for the execution of the more recent provider plug-in installation file 154 on its own at block 318. If the multi-plug-in framework 144 calls for the execution of the installation file 154, the multi-plug-in framework 144 may also include instructions to modify execution of the update program. For example, the multi-plug-in framework 144 may include using the installation file 154 to update code that has been integrated in the multi-plug-in framework 144 as discussed above. The multi-plug-in framework 144 may also suppress or automatically click through pop up alerts generated as part of the installation file's 154 execution. Once the multi-plug-in framework 144 is installed and the appropriate provider plug-in 145 is up to date, the provider plug-in 145 may prepare the coupon for printing, as described herein. Alternatively, the provider plug-ins 145 may execute update programs that run separately from the multi-plug-in framework 144.

FIG. 3B illustrates one embodiment of a method 300B to electronically distribute and print coupons. At block 320, the aggregator site 139 may execute instructions to evaluate one or more criteria to determine if the coupon is still available for printing. In some embodiments, the site 139 may execute instructions to determine a number of times a coupon has been printed and/or used, the geographic location of the user's web-enabled device 106, or the expiration date of a coupon offer, etc. For example, the aggregator site 139 may include instructions to query the appropriate provider system 110 from which the selected coupon(s) originate and evaluate various criteria corresponding to the coupon object 150 to determine if the coupon is still available for printing. Such criteria may include the coupon expiration date, a limit on the number of times a coupon object is allowed to be transformed into a printed coupon 112, or a geographic limitation on the electronic distribution of coupons, etc. If the coupon is not still available, the website 139 or multi-plug-in framework 144 may execute instructions to notify the user at block 322. Such a message could include a pop-up window with an interactive control or some other notification using graphics and/or text. Such a message may inform the user of the discontinuation or expiration of the coupon and may further inform the user of other coupons that may be of interest to the user. However, if the coupon is still available, the aggregator site 139 may communicate with the provider system 110 over the network 108 to prepare a printable version of the coupon object 150 and transmit the printable coupon to the web-enabled device 106 either directly or indirectly, via the aggregator server 116, at block 324. In some embodiments, the user's web-enabled device 106 may query the provider system 110 directly rather than via the aggregator server 116.

At block 326, the provider system 110 may send the digital information corresponding to the printable version of coupon object 150 to the aggregator server 116. The aggregator server 116 may relay the coupon object 150 data to the user's web-enabled device 106 at block 328. In other embodiments, the provider system 110 may send digital information which comprises the printable version of the coupon object 150 directly to the user's web-enabled device 106. The digital information which comprises the coupon 150 may include binary, assembly code, or a script written in any number of computer scripting languages currently developed or yet to be developed.

As shown in FIG. 1B, each coupon object 150 may include a unique coupon identifier 160 and a provider identifier 162. The unique coupon identifier 160 may be used by the aggregator system 116, the provider server 121, and/or the provider plug-in 145 to differentiate a coupon object 150 from other coupon objects 150. The provider identifier 162 allows the aggregator system 116 and/or the provider plug-ins 145 to know which provider server 121 from which to request a printable coupon. Additionally, the coupon object 150 may include an affiliate identifier (not shown) that corresponds to the coupon aggregator website 139. This affiliate identifier may allow the provider system to credit the coupon aggregator system 116 for a successful coupon printing to keep track of the number of times any particular coupon is printed. Alternatively, in embodiments discussed herein where the aggregator system 116 sends the coupon object 150 or one or more codes associated with the coupon object 150 to the provider server 121, the aggregator system 116 may increment a counter to track the number of times the coupon has been printed.

In some embodiments, the aggregator server 116 and/or the provider system 110 may make a record relating to the transmission of the digital information which comprises the coupon object 150. This record may be related to the coupon identifier 160 and/or the provider identifier 162. Additionally, this record may also be related to the affiliate identifier. The record of coupon data transmission may be used to count the number of times a coupon object 150 has been sent to a web-enabled device 106 and limit the number of times a coupon can be transmitted. The record may also be used to compile usage statistics, or to create a basis on which the entity that owns the provider system makes payments to the entity that owns the aggregator.

At block 330, once the user's web-enabled device 106 has received the digital information which comprises the coupon object 150, the appropriate affiliate plug-in 145 for the coupon object 150 (i.e. the affiliate plug-in 145 which correlates to the provider system 110 from which the coupon originates) may cause instructions to be executed by the processor to decode the digital information corresponding to the coupon object 150 and add the coupon to user's printer queue 146. In some embodiments, the multi-plug-in framework 144 may report a successful printing to the aggregator server 116 over the Internet 108 and the appropriate affiliate plug-in 145 may report a successful printing to the appropriate provider system 110 over the Internet 108. The printer 107 reads the printer queue 146 and then prints the coupon, creating a physical copy of the coupon 107A which can be taken to a brick and mortar store.

Referencing FIG. 4, one embodiment of the coupon aggregator website 139 may incorporate the graphical representation of a multiplicity of coupon objects 150. The processor 118 may execute instructions to render such coupon objects 150 as virtual coupons 402 on the website 139, to display graphics or videos 403 of the product or service, textual information 404 regarding the name of the brand or maker of the product or service, a description 406 of the discount offer and its terms, information regarding the source of the coupon (i.e. which provider system or retailer), and/or an interactive control 408 (e.g. a check box, a selectable border etc.) that causes a processor to execute instructions to select the coupon to print as well as other elements. The virtual coupons 402 may be arranged in any number of fashions, including but not limited to being grouped according to providers of the coupons, the type of good or service for which the coupon is redeemable, the amount of money that can be saved using the coupon, the expiration date of the coupon etc. Coupon objects 150 may be assembled, stored in the data warehouse 120 or program memory 130, and posted to the website as new coupons become available and removed when the coupon offers have ended.

The coupon aggregator website 139 may also have one or more search functions including instructions stored in memory that direct the processor to parse through the coupon objects 150 stored in the data warehouse 120 or program memory 130. The coupon aggregator website 139 may have a batch print capability such that multiple coupons can be selected, fetched, and printed in the same transaction. This batch print capability may include instructions stored in memory which cause the processor to bundle print requests (discussed herein) and execute them together so that user input is minimized. To facilitate batch printing, the aggregator website 139 may incorporate an object comprising a “Print Your Coupons” interactive control 410. Selection of this interactive control 410 may cause execution of the batch print instructions.

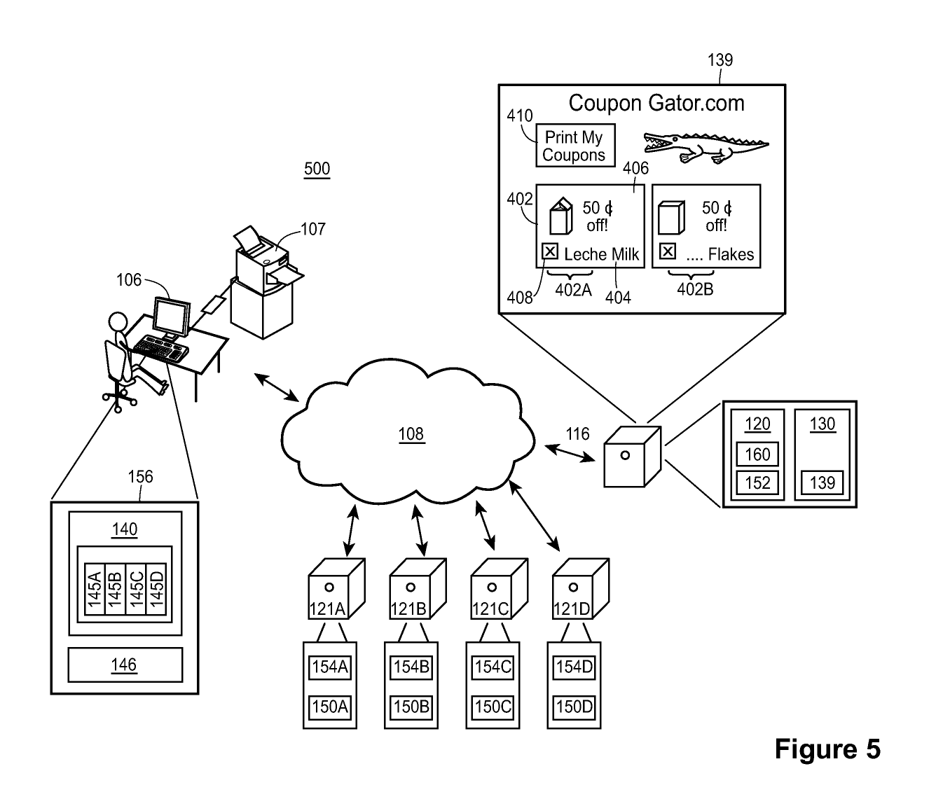

With reference to FIG. 5, a system for electronic distribution and printing of a coupon 500 using the system 100 may proceed generally as follows. Travis, a customer of Fresh Foods Grocery, may use his network-enabled laptop computer 106 or other computing device to log onto CouponGator.com 139, a website that aggregates and displays coupons from various manufacturers and retailers. The coupons displayed on CouponGator.com may be originally posted on other websites, but CouponGator.com may display the coupons on the website as part of an aggregator program.

Travis wants to purchase milk and cereal from Fresh Foods Grocery, so he searches CouponGator.com for milk and cereal coupons. Travis may find coupons for 50¢ off Leche Milk and Fiberific Bran Flakes Cereal. Travis may then check a box 408 on the website 139 that is associated with the graphical rendition 402 of each of the desired coupons 150 and click an interactive control on the website that reads “Print My Coupons” 410. If Travis has not printed a coupon from either of the providers from which his selected coupons originate, selecting the interactive control 410 may cause instructions to be sent from the aggregator server 116 through the network 108 to the memory of Travis's web-enabled device 106. These instructions are executed by the processor in Travis's device 106 to launch a pop-up window telling him that in order to print the coupons he requested, he must first run the CouponGator batch plug-in installer 152. Travis may click an interactive control that reads “Install” and cause the processor in Travis's device 106 to initiate a function call to the CouponGator web server 116 to send the executable file that makes up the batch plug-in installer 152 to Travis's laptop's program memory 156. This batch installer 152 may automatically download all printer plug-in applications that correspond to coupons displayed in the CouponGator website and that are not currently installed on the device. Alternatively, the installer 152 may only download missing plug-ins that also correspond to a user-selected coupon. The installer 152 may include instructions to walk Travis through the installations of each of the plug-ins 145 that correspond to the vendors that provide coupons to CouponGator. The batch installer 153 may include instructions to log onto the web server 121 of LotsOCoupons.com (i.e., the site on which the Leche Milk coupon was originally posted) to download and execute the LotsOCoupons.com printer plug-in installation program 154. The batch installer 152 may also log onto the web server of TonsOCoupons.com (i.e., the site on which the Fiberific Bran Flakes Cereal coupon was originally posted) to download and execute the TonsOCoupons.com plug-in installer 154, as well. In some embodiments, the batch installer 152 may also download and execute provider printer plug-in installer programs 154 offered by various other sites which also display coupons on CouponGator.com from their respective servers 121. After each plug-in 145 has been installed, the batch installer 152 may terminate.

After installation, the browser program 140 may load the provider plug-ins 145A and 145B and cause their instructions to be executed on the processor (i.e., instructions corresponding to the plug-ins 145 for LotsOCoupons.com and TonsOCoupons.com) to print the coupons Travis selected during his visit to CouponGator.com. Both plug-ins 145A and 145B may also cause instructions to be executed to fetch a printable coupon from their respective web servers 121A and 121B. The web servers 121A and 121B may then generate printable coupons corresponding to the provider coupon objects 150A and 150B located on the respective servers. In some embodiments, the servers 121A and 121B include instructions to generate PDF files for each coupon. The web servers 121A and 121B may also execute instructions to transmit the PDF files to Travis's laptop 106 over his Internet connection 108. In other embodiments, the servers 121A and 121B may include instructions to send data (e.g., vector or other data) to the device 106 which may then be converted (i.e., rasterized) into a printable coupon image. Each provider plug-in 145 may then add the PDF file it received from its provider web server 121 to Travis's printer queue 146 (i.e., the plug-in 145A added the printable coupon from server 121A to the printer queue 146 and the plug-in 145B added the printable coupon from server 121B to the printer queue 146). The provider plug-in 145A may add its coupon to the printer queue as a first separate print job and the provider plug-in 145B may add its coupon to the printer queue as a second separate print job. Alternatively, the printable coupons corresponding to plug-ins 145A and 145B may be grouped together as a single print job. Once added to the printer queue 146, Travis's printer software may execute instructions to activate his laser printer 107 and began to print the coupons. Moments later, in Travis's printer tray are freshly printed coupons 112 for Leche Milk and Fiberific Bran Flake Cereal that Travis puts in his pocket and takes with him to Fresh Food Grocery. At the store, Travis presents the coupons to the cashier who scans a barcode printed on each and applies the 50¢ discounts.

The system and method described herein may use an aggregator website to electronically distribute coupons which are then turned into physical coupons by a printer. Aggregator sites collect coupon deals available from multiple coupon vendor websites and present them in a single repository. Due to the necessities inherent in transforming an infinitely duplicable electronic coupon into a limited number of physical copies, coupon vendors must carefully control the number of times a coupon can be printed. These limitation methods may interfere with the efficiency of the aggregator model. In the various embodiments described above, the multi-plug-in framework 144, multi-plug-in installation program 153, or the batch installer 152 may allow installation of multiple printer plug-ins 145 that permit management and printing of coupons from several different sources that each may require various rules for strict monitoring and limiting coupon printing. By providing a single interface for the installation of printer plug-ins from multiple sources, the embodiments described herein may simplify and streamline online coupon printing.

The systems 100, 500 may include but is not limited to any combination of a LAN, a MAN, a WAN, a mobile, a wired or wireless network, a private network, or a virtual private network. Moreover, while only one client computing device 106 is illustrated in FIGS. 1 and 5 to simplify and clarify the description, it is understood that any number of client computers are supported and can be in communication within the systems 100, 500.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. As used herein any reference to a “plug-in” or “plug-ins” may mean a browser plug-in, a separately executable program, an applet, an app, a browser extension, a browser module, or any code, binary digits, machine code, programming code, high level language, assembly code, or other instructions that can be added to a computer system to provide extra functions or features.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system for digitally distributing and printing coupons for brink and mortar retail establishments for purposes of illustration only. One skilled in the art will readily recognize from the following discussion that alternative embodiments of the structures and methods illustrated herein may be employed without departing from the principles described herein

Upon reading this disclosure, those of skill in the art will appreciate still additional alternative structural and functional designs for a system and a process for digitally distributing and printing coupons through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed:

1. A method for electronically distributing and printing a coupon from a coupon aggregator website comprising:
receiving, at a coupon aggregator system, coupon objects corresponding to one of a plurality of distinct plug-ins stored on a plurality of remote servers, each distinct plug-in including instructions that, upon execution, format the coupon object corresponding to the distinct plug-in for printing at a client computing device;
electronically hosting, at the coupon aggregator system, a coupon aggregator website and a batch installer, the batch installer corresponding to the distinct plug-ins stored on the remote servers;
sending the batch installer from the coupon aggregator website to a client computing device in response to a request from the client computing device, the batch installer including instructions that, upon execution:
cause one or more remote servers having a distinct plug-in corresponding to the batch installer to send its distinct plug-in to the client computing device,
cause the installation of each sent distinct plug-in on the remote computing device; and
sending a coupon object to the client computing device from the coupon aggregator system, the sent coupon object corresponding to one of the distinct plug-ins installed on the client computing device.

2. The method of claim 1, wherein the batch installer is a shared library file.

3. The method of claim 1, wherein the batch installer is a stand-alone executable file.

4. The method of claim 1, wherein the batch installer is a script that is run by the client computing device.

5. The method of claim 1, wherein the batch installer further includes instructions that, upon execution, install an affiliate multi-plug-in framework.

6. The method of claim 1, further comprising tracking a number of time the one or more coupon objects are printed.

7. The method of claim 6, further comprising:
receiving at the client computing device the coupon object; and
printing the coupon object.

8. The method of claim 6, further comprising preventing the client computing device from printing the coupon object because of one or more of (i) the number of times the coupon object has been printed has exceeded a threshold value, (ii) a physical location of the client computing device, or (iii) an expiration date of the coupon object.

9. A system comprising:
a backend server including a first processor and a first program memory storing instructions for execution by the first processor to:
receive coupon objects corresponding to one of a plurality of distinct plug-ins stored on a plurality of provider servers each distinct plug-in including instructions that, upon execution, format the coupon object corresponding to the distinct plug-in for printing at a client computing device, and
host a coupon aggregator website and a batch installer;
a plurality of provider servers communicatively coupled to the backend server, each server including a second processor and a second program memory storing a distinct provider plug-in, and instructions for execution by each second processor to send the distinct provider plug-in to the client computing device; and
a client computing device communicatively coupled to the backend server including a third processor and a third program memory storing instructions for execution by the third processor to receive the batch installer;
wherein the batch installer includes instructions for execution by the third processor to:
cause the plurality of provider servers to having a distinct plug-in corresponding to the batch installer to send its distinct plug-in to the client computing device, and
cause the installation of each sent distinct plug-in on the remote computing device.

10. The system of claim 1, wherein the batch installer is a shared library file.

11. The system of claim 1, wherein the batch installer is a stand-alone executable file.

12. The system of claim 1, wherein the batch installer is a script that is run by the client computing device.

13. The system of claim 1, wherein the batch installer further includes instructions for execution by the third processor to install an affiliate multi-plug-in framework.

14. The system of claim 1, wherein the backend server includes a counter to track a number of time the one or more coupon objects are printed.

15. A tangible computer readable medium storing instructions adapted for execution by one or more processors, the instructions, when executed, cause the processors to:
receive, at a coupon aggregator system, coupon objects corresponding to one of a plurality of distinct plug-ins stored on a plurality of remote servers, each distinct plug-in including instructions that, upon execution, format the coupon object corresponding to the distinct plug-in for printing at a client computing device;
electronically host, at the coupon aggregator system, a coupon aggregator website and a batch installer, the batch installer corresponding to the distinct plug-ins stored on the remote servers;
send the batch installer from the coupon aggregator website to a client computing device in response to a request from the client computing device, the batch installer including instructions that, upon execution:
cause one or more remote servers having a distinct plug-in corresponding to the batch installer to send its distinct plug-in to the client computing device,
cause the installation of each sent distinct plug-in on the remote computing device; and
send a coupon object to the client computing device from the coupon aggregator system, the sent coupon object corresponding to one of the distinct plug-ins installed on the client computing device.

16. The tangible computer readable medium of claim 15, wherein the batch installer is a shared library file.

17. The tangible computer readable medium of claim 15, wherein the batch installer is a stand-alone executable file.

18. The tangible computer readable medium of claim 15, wherein the batch installer is a script that is run by the client computing device.

19. The tangible computer readable medium of claim 15, wherein the batch installer further includes instructions that, upon execution, install an affiliate multi-plug-in framework.

20. The tangible computer readable medium of claim 15, further storing instructions adapted for execution by one or more processors, the instructions, when executed, cause the processors to track a number of time the one or more coupon objects are printed.
